(19) United States
(12) Patent Application Publication
(10) Pub. No.: US 2023/0161072 A1
(43) Pub. Date: May 25, 2023

(54) Predictive Hydrological Impact Diagnostic System

(71) Applicant: AT&T Intellectual Property I, L.P., Atlanta, GA (US)

(72) Inventors: Daniel Addington, Dawsonville, GA (US); Christopher Maltese, Boynton Beach, FL (US); Eli Siegel, Chicago, IL (US)

(73) Assignee: AT&T Intellectual Property I, L.P., Atlanta, GA (US)

(21) Appl. No.: 17/533,222

(22) Filed: Nov. 23, 2021

(51) Int. Cl. G01W 1/10

(52) U.S. Cl. CPC G01W 1/10

(57) ABSTRACT

The concepts and technologies disclosed herein are directed towards a predictive hydrological impact diagnosis system. According to one aspect disclosed herein, the system can obtain weather data associated with an area. The weather data can include an interval rainfall forecast and a total accumulated rainfall forecast for the area. The system can execute a flood index algorithm using the interval rainfall forecast and the total accumulated rainfall forecast. In response to executing the flood index algorithm, the system can obtain an output of the flood index algorithm. The output can include flood index data for the area. The system can plot the flood index data on a graph to show a forecasted rainfall intensity over a time. The system can determine hydrological potential energy data for the area. This data is representative of a cumulative area of the graph that is above a predetermined threshold value.

### BACKGROUND

During times of heavy rainfall such as thunderstorms, monsoons, and hurricanes, business decision makers have a need for both accurate and useful weather information and interpretation. This is particularly true when it comes to deciding if a given building requires extensive flood mitigation such as sandbagging to protect against flood damage due to heavy rainfall. Decision makers also have the need for that information to be as granular as possible and applicable to all locations associated with a given business.

In prior solutions, business decision makers would rely on high level rainfall and flood forecasts obtained from open sources and combine these forecasts with local knowledge of historical flood damage to determine the threat severity for a given building. This approach does not consider that ever-fluctuating rainfall rates can mean the difference between a building that requires extensive preparations for significant flooding events and a building that requires only minimal, if any, preparation for flood control.

### SUMMARY

Concepts and technologies disclosed herein are directed to a predictive hydrological impact diagnostic system. According to one aspect disclosed herein, a predictive hydrological impact diagnostic system can obtain weather data associated with a given area. The weather data can include predicted rainfall for a fixed number of future time intervals; all intervals are of equal length. The area for which weather data is obtained can include one or more assets, such as one or more buildings and/or other structures which may be owned and/or operated by a business. The area can be defined by a geographic polygon where heavy rainfall is forecast. Each individual building location can be defined by its latitude and longitude coordinates. The business may desire a detailed hydrological report that can determine if any building within the area may be subject to a flooding event so that the business can take precautions to attempt to mitigate damage from the flooding event. Although the area will be described herein in context of an area that includes one or more buildings owned and/or operated by a business, the concepts and technologies disclosed herein are applicable to any structure such as homes (e.g., single family, townhome, apartment, condominium, etc.), temporary structures (e.g., tents), sporting event venues (e.g., stadiums), and the like. More generally, these concepts and technologies are applicable for any entity with an interest in flood damage protection for their real estate assets.

The system can execute a flood index algorithm using the interval rainfall forecast. In response to executing the flood index algorithm, the system can obtain an output of the flood index algorithm. The output can include flood index data for the area. The system can plot the flood index data on a graph to show the forecasted rainfall intensity over time. Using a chosen threshold, indictive of heavy rainfall capable of causing significant flooding, the system can then determine the area of the graph above this chosen threshold. This data is representative of a cumulative area of the graph that is above the predetermined threshold value and can be referred to as hydrological potential energy.

In some embodiments, the system can execute the flood index algorithm using a time interval parameter, a heavy rain threshold parameter, and a total rainfall threshold parameter. The time interval parameter is a number determined by the length of time in each of the intervals in the rainfall forecast. It is the number of such intervals in an hour. The heavy rain threshold parameter represents the value (in inches per hour) determined to be indicative of a heavy rain event (e.g., 0.31 inches per hour). The total rainfall threshold parameter represents the value (in inches) determined to be indicative of a total amount of rainfall that can create a flood event considering the resident soil moisture (e.g., 2.1 inches). The flood index algorithm can be defined as being equal to

$$( \frac{( X * Y )}{Z} ) * ( \frac{T}{U} ) ,$$

wherein: X is representative of the interval rainfall forecast in inches; T is representative of the total accumulated rainfall forecast up to and including the given interval; the time interval parameter is equal to Y, the heavy rain threshold parameter is equal to Z and the total rainfall threshold parameter is equal to U.

In some embodiments, the system can determine, based upon the flood index formula output, that the building is at risk of a flood event. The system can generate and output a report identifying that the building is at risk of the flood event. Personnel can use the report to perform appropriate action in preparation for the flood event.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

Other systems, methods, and/or computer program products according to embodiments will be or become apparent to one with skill in the art upon review of the following drawings and detailed description. It is intended that all such additional systems, methods, and/or computer program products be included within this description, be within the scope of this disclosure.

### BRIEF DESCRIPTION OF THE DRAWINGS

FIG. 1 is a block diagram illustrating aspects of an illustrative operating environment for various concepts and technologies disclosed herein.

FIG. 2 is an example graph depicting a flood index determined by a predictive hydrological impact diagnostic system, according to an illustrated embodiment of the concepts and technologies disclosed herein.

FIG. 3 is a flow diagram illustrating aspects of a method for determining whether an area is at risk of a flooding event, according to an illustrative embodiment of the concepts and technologies disclosed herein.

FIG. 4 is a block diagram illustrating an example computer system capable of implementing aspects of the concepts and technologies disclosed herein.

FIG. 5 is a block diagram illustrating an example mobile device capable of implementing aspects of the concepts and technologies disclosed herein.

FIG. 6 is a block diagram illustrating an example network capable of implementing aspects of the concepts and technologies disclosed herein.

FIG. 7 is a block diagram illustrating an example machine learning system capable of implementing aspects of the concepts and technologies disclosed herein.

FIG. 8 is a block diagram illustrating a virtualized cloud architecture capable of implementing aspects of the concepts and technologies disclosed herein.

### DETAILED DESCRIPTION

The concepts and technologies disclosed herein are directed to a predictive hydrological impact diagnostic system that provides a more granular evaluation of flood risk by incorporating rainfall forecasts of high spatial and temporal resolution. These forecasts can be fed into a flood index algorithm. The output of this algorithm can be used to identify one or more assets (e.g., building(s) and/or other structure(s)) that are likely to see prolonged and elevated rainfall rates and corresponding large hydrological potential energy values, which provide a measurement of flood intensity and duration. The identified assets can be paired with other indicators including a historical flood record, flood zone type, and expected depth of any potential storm surge associated with the asset(s) in order to more accurately and widely determine the probability of a severe flooding event than the tools currently used today.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

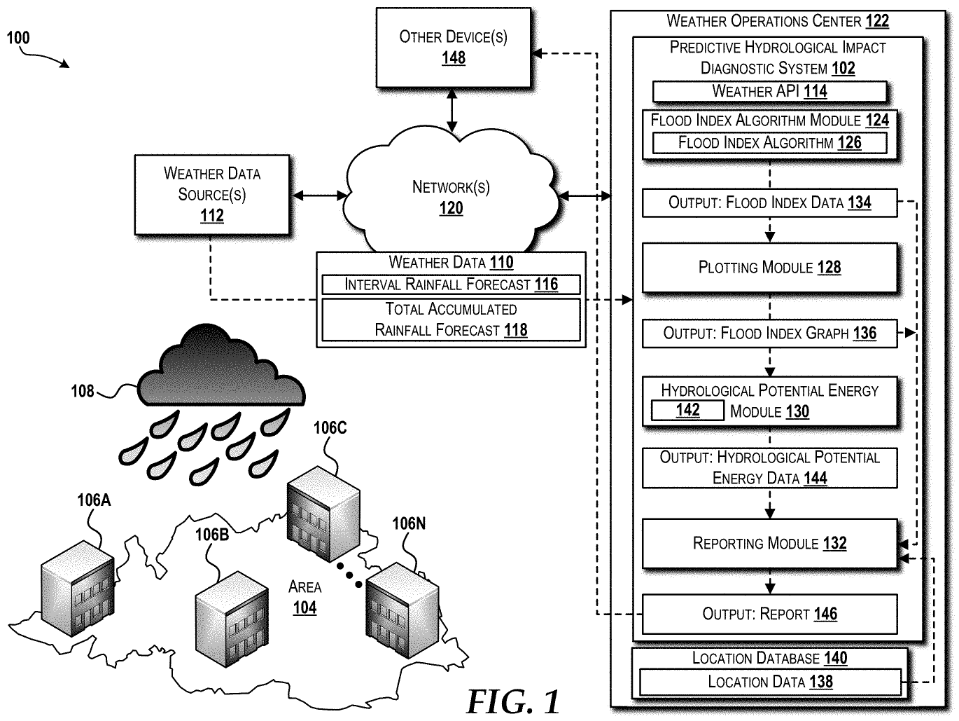

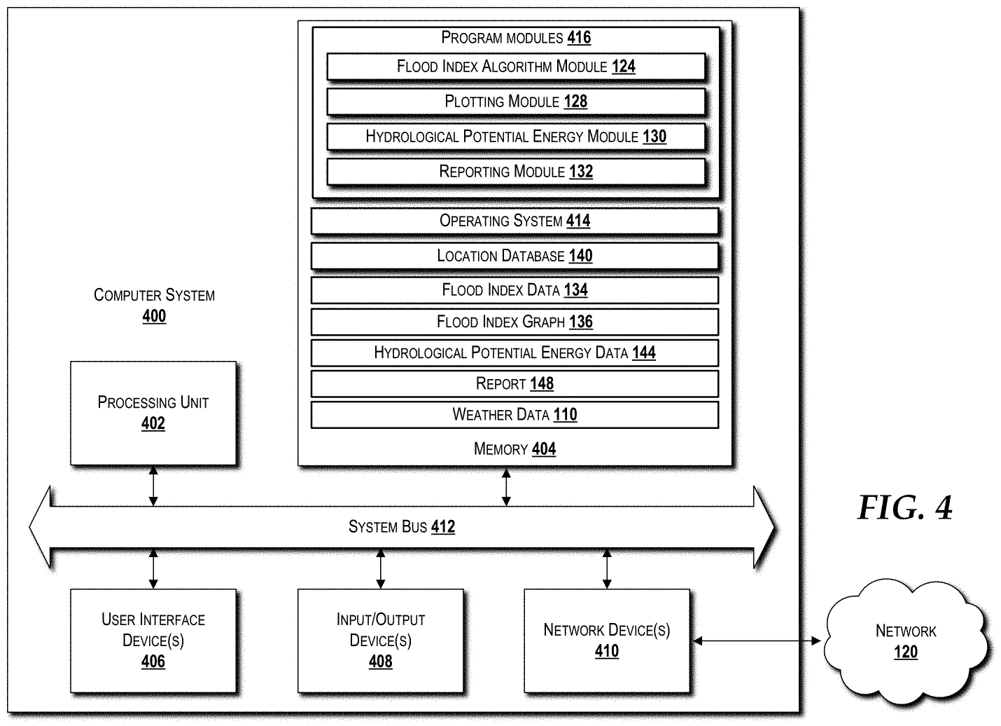

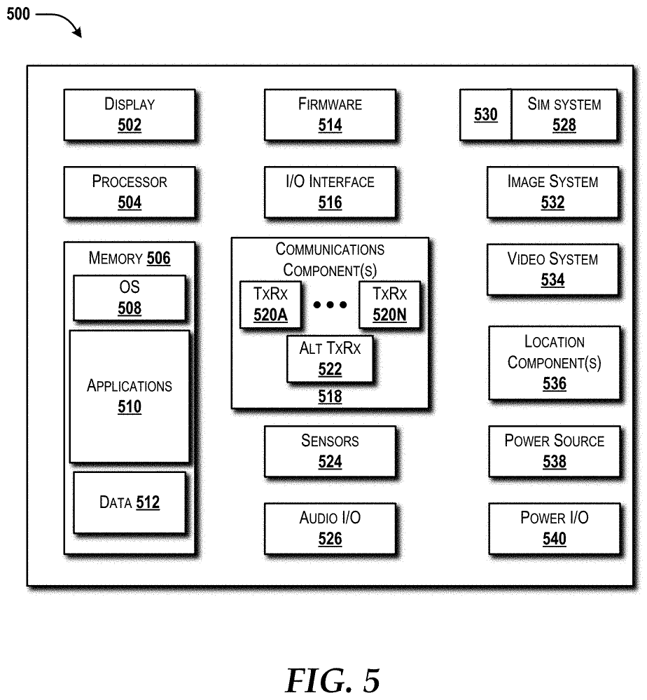

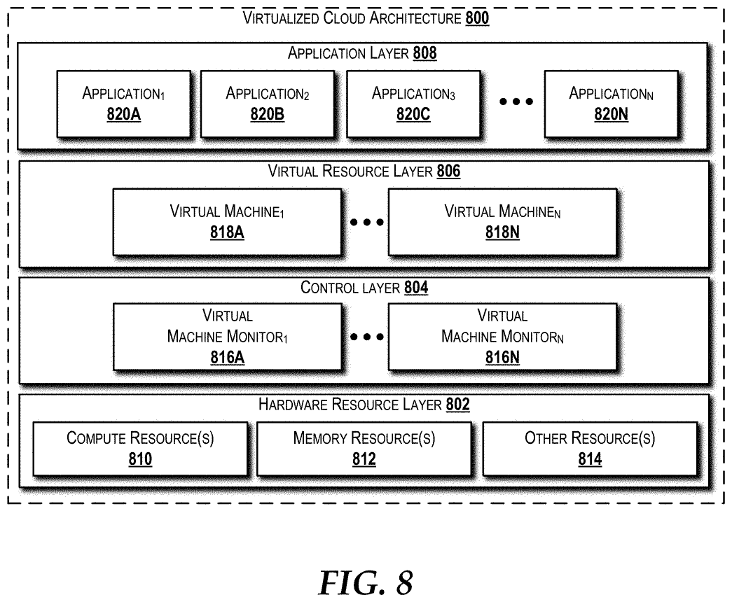

Turning now to FIG. 1, an operating environment 100 in which embodiments of the concepts and technologies disclosed herein will be described. The operating environment 100 includes a predictive hydrological impact diagnostic system 102 that implements a novel algorithm to provide a granular evaluation of flood risk for a given geographical area 104 (e.g., country, region, state, city, other municipality, or custom area), and particularly, one or more assets 106A-106N (hereinafter referred to collectively as “assets 106” or individually as “asset 106”) located within the area 104. The predictive hydrological impact diagnostic system 102 can be implemented as a computer system (best shown in FIG. 4) or a portion thereof. Alternatively, the predictive hydrological impact diagnostic system 102 can be implemented as a mobile device (best shown in FIG. 5) or a portion thereof. The predictive hydrological impact diagnostic system 102 can be implemented as part of a virtualized cloud architecture (best shown in FIG. 8). The assets 106 can be any place or thing that is to be evaluated for flood risk. The assets 106 will be described herein as buildings or other structures in one non-limiting example. It should be understood, however, that the concepts and technologies disclosed herein are not limited to buildings or other structures. Moreover, the assets 106 may be permanently (e.g., a building) or temporarily (e.g., a tent) positioned within the area 104.

The area 104, and consequently, the assets 106 can be subjected to a weather event 108. The weather event 108 includes a rainfall component but additionally may include other forms of precipitation (e.g., sleet, snow, and/or hail). The weather event 108 may be a thunderstorm, a hurricane, a tornado, or the like. For purposes of the concepts and technologies disclosed herein, the rainfall component of the weather event 108 will be the focus.

The weather event 108 can be associated with weather data 110 that can be obtained by the predictive hydrological impact diagnostic system 102 from one or more weather data sources 112 (hereinafter referred to collectively as “weather data sources 112” or individually as “weather data source 112”). The weather data sources 112 can be or can include one or more weather data services. One such service is available from Baron Services, Inc., although other weather data services are contemplated. In some embodiments, the predictive hydrological impact diagnostic system 102 utilizes a weather application programming interface (“API”) 114 to access the weather data 110 from the weather data source 112. The weather data sources 112 can be or can include one or more weather stations or an aggregator of the weather data 110 obtained from multiple weather stations. Other weather data sources 112 are contemplated.

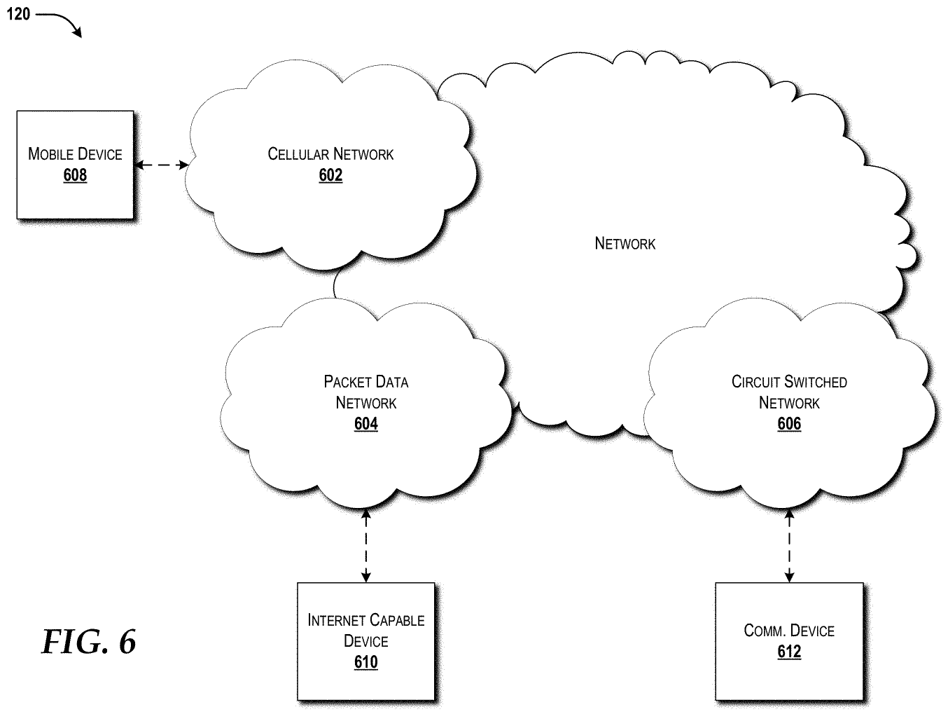

In the illustrated example, the weather data 110 includes an interval rainfall forecast 116. The weather data 110 can include current weather data, other forecasted weather data, and/or historical weather data in addition to the interval rainfall forecast 116. In some embodiments, the current weather data, the other forecasted weather data, and/or the historical weather data can be used to further refine an output of the predictive hydrological impact diagnostic system 102. The interval rainfall forecast 116 can include a measurement (e.g., in units such as inches or centimeters) of the amount of rainfall forecasted for each time interval. For each time interval the total accumulated rainfall forecast 118 is the running total of the interval rainfall forecasts of all the previous time intervals. Thus, is the total accumulated rainfall forecast 118 can include a measurement (e.g., in units such as inches or centimeters) of the amount of total rainfall forecasted for a time period (e.g., 56 hours). As will be described in further detail below, the interval rainfall forecast 116 and the total accumulated rainfall forecast 118 can be established based upon the needs of a given implementation. The weather data sources 112 can provide the weather data 110 to the predictive hydrological impact diagnostic system 102 via one or more networks 120 (best illustrated and described herein with reference to FIG. 6).

In the illustrated example, the predictive hydrological impact diagnostic system 102 is shown operating as part of a weather operations center 122. The weather operations center 122 can be associated with a business, such as the owner and/or operator of one or more of the assets 106. The weather operations center 122 can be associated with a government agency, such as the Federal Emergency Management Agency (“FEMA”). It should be understood, however, that the predictive hydrological impact diagnostic system 102 may be deployed separately from the weather operations center 122.

The predictive hydrological impact diagnostic system 102 can execute, via one or more processing components (best shown in FIGS. 4, 5, and 8), a plurality of modules, including a flood index algorithm module 124 that can implement a flood index algorithm 126, a plotting module 128, a hydrological potential energy module 130, and a reporting module 132, each of which can include instructions that, when executed by the processing component(s) of the predictive hydrological impact diagnostic system 102, cause the predictive hydrological impact diagnostic system 102 to perform operations described in further detail herein. Although these modules are shown as separate modules, two or more of these modules can be combined, for example, in one or more applications executed by the predictive hydrological impact diagnostic system 102. Moreover, it is contemplated that these modules may be executed by other systems that operate remote from and in communication with the predictive hydrological impact diagnostic system 102, such as via the network(s) 120 (best shown in FIG. 6), including local and/or wide area networks, for example.

The predictive hydrological impact diagnostic system 102 can obtain the weather data 110 from the weather data source(s) 112 via the weather API 114 or directly. The predictive hydrological impact diagnostic system 102 can establish a schedule to periodically obtain the weather data 110. The predictive hydrological impact diagnostic system 102 can receive the weather data 110 continuously. The predictive hydrological impact diagnostic system 102 can request the weather data 110 from the weather data source(s) 112. The predictive hydrological impact diagnostic system 102 can establish one or more conditions under which the weather data source(s) 112 should provide the weather data 110 to the predictive hydrological impact diagnostic system 102. For example, the predictive hydrological impact diagnostic system 102 can establish one or more rules that define the condition(s) under which the weather data source(s) 112 should provide the weather data 110. These conditions can be or can include a threshold amount of rain for the interval rainfall forecast 116 and/or the total accumulated rainfall forecast 118.

After the predictive hydrological impact diagnostic system 102 obtains the weather data 110 from the weather data source(s) 112, the predictive hydrological impact diagnostic system 102 can execute the flood index algorithm module 124 and thereby the flood index algorithm 126. In some embodiments, the predictive hydrological impact diagnostic system 102 can execute the flood index algorithm 126 using a time interval parameter, a heavy rain threshold parameter, and a total rainfall threshold parameter. The time interval parameter is a number determined by the length of the intervals in the rainfall forecast, namely the number of such intervals in an hour. The heavy rain threshold parameter represents a value (e.g., measured in inches per hour) determined to be indicative of a heavy rain event (e.g., 0.31 inches per hour). The total rainfall threshold parameter represents the value (e.g., measured in inches) determined to be indicative of a total amount of rainfall that can create a flood event when compared to resident soil moisture (e.g., 2.1 inches). Those skilled in the art will appreciate that the heavy rain threshold parameter of 0.31 inches per hour is an established value that is representative of the amount of rain per hour considered by weather scientists as being a heavy rain event. It should be understood, however, that this value may change over time to accommodate a need for different thresholds in the future. Those skilled in the art also will appreciate that the total rainfall threshold parameter of 2.1 inches is often the amount needed to trigger flash flooding when compared to soil moisture levels.

In some embodiments, the flood index algorithm 126 can define a flood index as being equal to

$$( \frac{( X * Y )}{Z} ) * ( \frac{T}{U} ) ,$$

wherein: X is representative of the forecasted rainfall amount for each time interval in the interval rainfall forecast 116, which uses a 15-minute time interval; T is representative of a running total of forecasted rainfall up to and including the given interval; the time interval constant is 4, which is representative of the number of 15-minute time intervals in one hour; the heavy rain threshold parameter is 0.31, which is representative of a number of inches of rain per hour that is considered to be heavy; and the total rainfall threshold parameter which in this case is 2.1, is representative of a total number of inches of rain that is considered to be heavy when compared to resident soil moisture. Output of the flood index algorithm 126 can include flood index data 134.

The flood index algorithm module 124 can provide the flood index data 134 to the plotting module 128. The plotting module 128 can plot the flood index data 134 on a flood index graph 136. In some embodiments, the flood index graph 136 can illustrate a likelihood that the area 104 will see significant flooding based upon the weather data 110. Location data 138 associated with the area 104 can be stored in a location database 140. The location data 138 can include latitude and longitude pairs that define, at least in part, the area 104. The location database 140 is shown as part of the weather operations center 122 but alternatively may be part of the predictive hydrological impact diagnostic system 102 or remotely accessible via the network(s) 120. In some other embodiments, the location data 138 can pinpoint one or more specific assets 106. The granularity of the flood index data 134 and the resultant flood index graph 136 can be determined based upon the resolution of the weather data 110. For example, as the resolution of the weather data 110 increases, so does the accuracy of the flood index data 134, and consequently, the flood index graph 136.

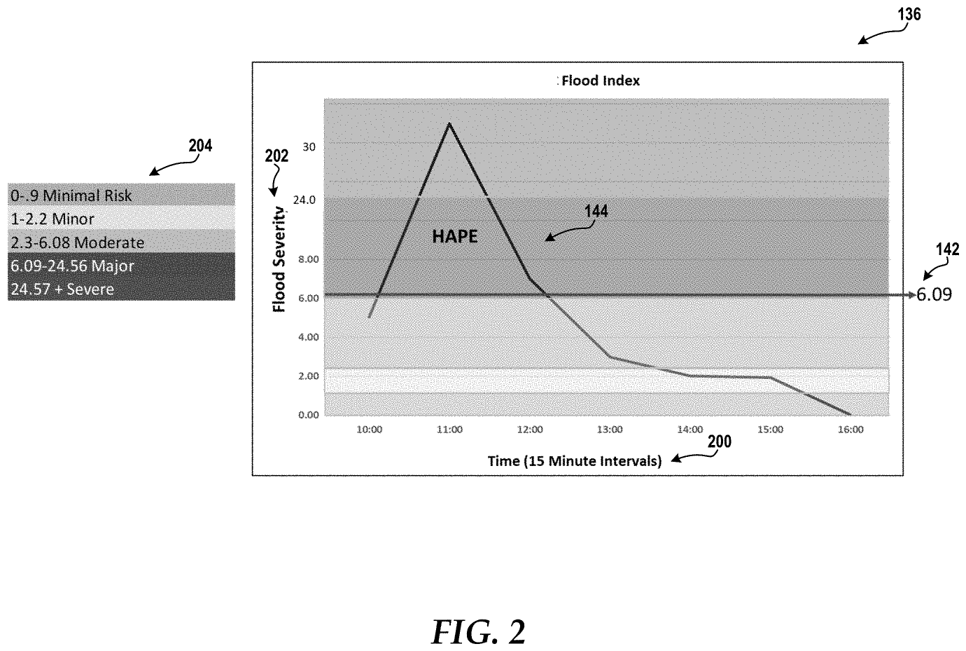

The plotting module 128 can provide the flood index graph 136 to the hydrological potential energy module 130. The hydrological potential energy module 130 can calculate a graph area of a portion of the flood index graph 136 that is above a flood index threshold 142 to quantify a level of expected flood severity. This calculated area is output by the hydrological potential energy module 130 as hydrological potential energy (shown as “HAPE” in FIG. 2) data 144. It should be understood that HAPE is the area under the curve of the flood index graph 136 but above the flood index threshold 142. An example of the flood index graph 136 will now be described herein with reference to FIG. 2.

Turning briefly to FIG. 2, the flood index graph 136 is shown according to one exemplary example. The flood index graph 136 shows a time on an X-axis in 15-minute intervals (shown generally as 200). The intervals can be changed based upon the interval rainfall forecast 116 (e.g., a 30-minute interval forecast instead of a 15-minute interval forecast). The flood index graph 136 also shows flood severity on a Y-axis (shown generally as 202). A color-coded flood severity scale 204 indicates flood index values indicative of minimal flood risk (0-0.9), minor flood risk (1-2.2), moderate flood risk (2.3-6.08), major flood risk (6.09-24.56), and severe flood risk (24.57 or greater). In the illustrated example, the flood index threshold 142 is set to 6.09. The flood index threshold 142 can be changed based upon the needs of a given implementation. It should be understood, however, that the flood index threshold 142 set to 6.09 has been shown through experimentation to be accurate.

Returning to FIG. 1, the hydrological potential energy module 130 can provide the hydrological potential energy data 144 to the reporting module 132. The reporting module 132 also can receive the flood index graph 136 from the plotting module 128, the flood index data 134 from the flood index algorithm module 124, the weather data 110 including the interval rainfall forecast 116 and the total accumulated rainfall forecast 118, the location data 138, or some combination thereof. The reporting module 128 can generate a report 146 that contains all or a portion of the aforementioned data. The report 146 also can indicate whether one or more of the assets 106 are at risk of a flood event, and if so, the severity of that risk according to the flood index values determined by the predictive hydrological impact diagnostic system 102. The reporting module 132 can send the report 146 to one or more other devices 148 associated with personnel that has some interest in the asset(s) 106. For example, the personnel may be or may include managers, engineers, emergency response personnel, and/or the like that can take measures to mitigate or prevent flood damage to the asset(s) 106. The report 146 can be distributed to the other devices 148 via email, text message, application notification, facsimile, telephone call, some combination thereof, and/or the like. The other devices 148 can be computer systems such as illustrated and described herein with reference to FIG. 4 and/or mobile devices such as illustrated and described herein with reference to FIG. 5.

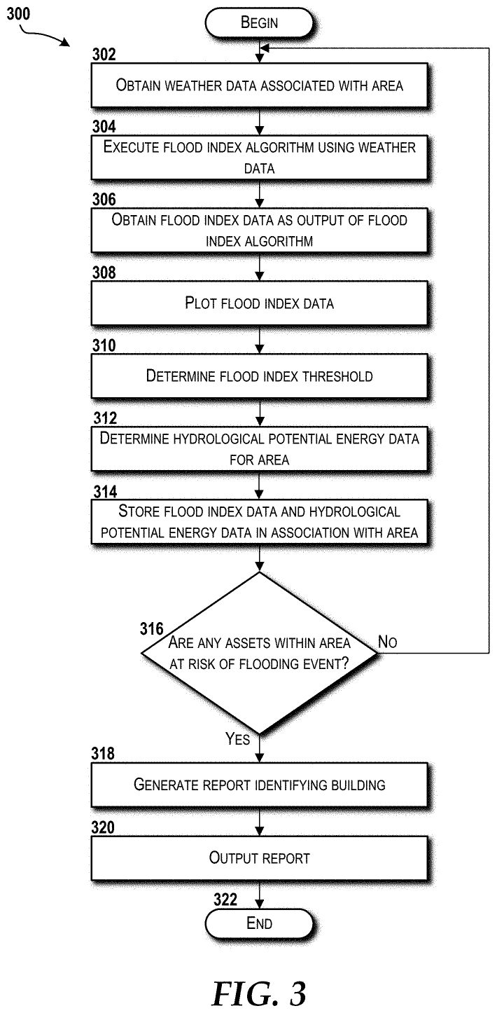

Turning now to FIG. 3, a flow diagram illustrating aspects of a method 300 for determining whether the area 104 or one or more of the assets 106 within the area 104 are at risk of a flooding event will be described, according to an illustrative embodiment. It should be understood that the operations of the method disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the method disclosed herein can be ended at any time and need not be performed in its entirety. Some or all operations of the method, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, or a portion thereof, to perform one or more operations, and/or causing the processor to direct other components of the computing system or device to perform one or more of the operations.

For purposes of illustrating and describing the concepts of the present disclosure, operations of the method disclosed herein are described as being performed alone or in combination via execution of one or more software modules, and/or other software/firmware components described herein. It should be understood that additional and/or alternative devices and/or network nodes can provide the functionality described herein via execution of one or more modules, applications, and/or other software. Thus, the illustrated embodiments are illustrative, and should not be viewed as being limiting in any way.

The method 300 will be described from the perspective of the predictive hydrological impact diagnostic system 102 executing the various modules described herein above with reference to FIG. 1. The predictive hydrological impact diagnostic system 102 can be implemented as a computer system 400 such as described herein with reference to FIG. 4, and as such, can execute the modules described herein above via one or more processing units 402 (best shown in FIG. 4). Alternatively, the predictive hydrological impact diagnostic system 102 can be implemented on a virtualized cloud architecture 800 such as described herein with reference to FIG. 8, and as such, can execute the modules described herein above via one or more compute resources 810 or virtualizations thereof (best shown in FIG. 8). These example implementations are merely exemplary and should not be construed as being limiting in any way.

The method 300 begins and proceeds to operation 302. From operation 302, the predictive hydrological impact diagnostic system 102 can obtain the weather data 110 associated with the area 104. It should be understood that the weather data 110 can include higher resolution data that pinpoints one or more of the assets 106 such as via latitude and longitude pairs. From operation 302, the method 300 can proceed to operation 304. At operation 304, the predictive hydrological impact diagnostic system 102 can execute the flood index algorithm 126 using the weather data 110. In some embodiments, the flood index algorithm 126 can define a flood index as being equal to

$$( \frac{( X * Y )}{Z} ) * ( \frac{T}{U} ) ,$$

wherein: X is representative of the interval rainfall forecast 116 which uses 15-minute intervals; T is representative of the total accumulated rainfall forecast 118 up to and including the given interval; the time interval constant is 4, which is representative of the number of 15 minute time intervals in one hour; the heavy rain threshold parameter is 0.31, which is representative of a number of inches of rain per hour that is considered to be heavy; and the total rainfall threshold parameter is 2.1, which is often representative of the total number of inches of rain that is considered to be heavy when compared to resident soil moisture.

From operation 304, the method 300 can proceed to operation 306. At operation 306, the predictive hydrological impact diagnostic system 102 can obtain the flood index data 134 as output of the flood index algorithm 126. From operation 306, the method 300 proceeds to operation 308. At operation 308, the predictive hydrological impact diagnostic system 102 can plot the flood index data 134 on the flood index graph 136 (an example of which is best shown in FIG. 2).

From operation 308, the method proceeds to operation 310. At operation 310, the predictive hydrological impact diagnostic system 102 can determine the flood index threshold 142. Although the flood index threshold 142 is described as being determined at this step, the flood index threshold 142 may be predetermined. In the examples disclosed herein, the flood index threshold 142 is set to 6.09. From operation 310, the method 300 proceeds to operation 312. At operation 312, the predictive hydrological impact diagnostic system 102 can determine the hydrological potential energy data 144 for the area 104 (or particular asset(s) 106 as the case may be). From operation 312, the method 300 proceeds to operation 314. At operation 314, the predictive hydrological impact diagnostic system 102 can store the flood index data 134 and the hydrological potential energy data 144 in association with the area 104 identified as part of the location data 138 in the location database 140.

From operation 314, the method 300 proceeds to operation 316. At operation 316, the predictive hydrological impact diagnostic system 102 can determine whether any of the assets 106 within the area 104 is/are at risk of a flooding event. If the predictive hydrological impact diagnostic system 102 determines that one or more of the assets 106 within the area 104 is/are at risk of a flooding event, the method 300 proceeds to operation 318. At operation 318, the predictive hydrological impact diagnostic system 102 can generate the report 146 identifying the asset(s) 106 that is/are at risk of a flooding event. From operation 318, the method 300 can proceed to operation 320. At operation 320, the predictive hydrological impact diagnostic system 102 can output the report 146 to one or more of the other devices 148.

From operation 320, the method 300 can proceed to operation 322. The method 300 can end at operation 322.

Returning to operation 316, if the predictive hydrological impact diagnostic system 102 determines that a building within the area is not at risk of a flooding event, the method 300 returns to operation 302. The method 300 then proceeds as described above.

It should be understood that multiple instances of the method 300 can be run sequentially or simultaneously for one or more areas. Moreover, certain values that are been described herein as constants can be manipulated based upon the needs of a given implementation. It should be understood that the constant values described herein have been tested and understood to be accurate for multiple scenarios.

Turning now to FIG. 4, a block diagram illustrating a computer system 400 configured to provide the functionality described herein in accordance with various embodiments. In some embodiments, the predictive hydrological impact diagnostic system 102 is configured the same as or similar to the computer system 400. In some embodiments, one or more of the weather data sources 112 can be configured the same as or similar to the computer system 400. In some embodiments, one or more of the other devices 148 can be configured the same as or similar to the computer system 400.

The computer system 400 includes a processing unit 402, a memory 404, one or more user interface devices 406, one or more input/output (“I/O”) devices 408, and one or more network devices 410, each of which is operatively connected to a system bus 412. The bus 412 enables bi-directional communication between the processing unit 402, the memory 404, the user interface devices 406, the I/O devices 408, and the network devices 410.

The processing unit 402 may be a standard central processor that performs arithmetic and logical operations, a more specific purpose programmable logic controller (“PLC”), a programmable gate array, or other type of processor known to those skilled in the art and suitable for controlling the operation of the server computer. The processing unit 402 can be a single processing unit or a multiple processing unit that includes more than one processing component. Processing units are generally known, and therefore are not described in further detail herein.

The memory 404 communicates with the processing unit 402 via the system bus 412. The memory 404 can include a single memory component or multiple memory components. In some embodiments, the memory 404 is operatively connected to a memory controller (not shown) that enables communication with the processing unit 402 via the system bus 412. The memory 404 includes an operating system 414 and one or more program modules 416. The operating system 414 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OSX, iOS, and/or families of operating systems from APPLE CORPORATION, the FREEB SD family of operating systems, the SOLARIS family of operating systems from ORACLE CORPORATION, other operating systems, and the like.

The program modules 416 may include various software and/or program modules described herein. The program modules 416 can include the flood index algorithm module 124, the plotting module 128, the hydrological potential energy module 130, and the reporting module 131. In some embodiments, multiple implementations of the computer system 400 can be used, wherein each implementation is configured to execute one or more of the program modules 416. The program modules 416 and/or other programs can be embodied in computer-readable media containing instructions that, when executed by the processing unit 402, perform the method 300 described herein. According to embodiments, the program modules 416 may be embodied in hardware, software, firmware, or any combination thereof. The memory 404 also can be configured to store the location database 140, the flood index data 134, the flood index graph 136, the hydrological potential energy data 144, the report 146, the weather data 110, and/or other data disclosed herein.

By way of example, and not limitation, computer-readable media may include any available computer storage media or communication media that can be accessed by the computer system 400. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 400. In the claims, the phrase “computer storage medium,” “computer-readable storage medium,” and variations thereof does not include waves or signals per se and/or communication media, and therefore should be construed as being directed to “non-transitory” media only.

The user interface devices 406 may include one or more devices with which a user accesses the computer system 400. The user interface devices 406 may include, but are not limited to, computers, servers, personal digital assistants, cellular phones, or any suitable computing devices. The I/O devices 408 enable a user to interface with the program modules 416. In one embodiment, the I/O devices 408 are operatively connected to an I/O controller (not shown) that enables communication with the processing unit 402 via the system bus 412. The I/O devices 408 may include one or more input devices, such as, but not limited to, a keyboard, a mouse, or an electronic stylus. Further, the I/O devices 408 may include one or more output devices, such as, but not limited to, a display screen or a printer.

The network devices 410 enable the computer system 400 to communicate with other networks or remote systems via the network(s) 120. Examples of the network devices 410 include, but are not limited to, a modem, a radio frequency (“RF”) or infrared (“IR”) transceiver, a telephonic interface, a bridge, a router, or a network card. The network 120 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such a WiMAX network, or a cellular network. Alternatively, the network 120 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

Turning now to FIG. 5, an illustrative mobile device 500 and components thereof will be described. In some embodiments, the predictive hydrological impact diagnostic system 102 can be configured the same as or similar to the mobile device 500. In some embodiments, one or more of the other devices 148 can be configured the same as or similar to the mobile device 500. While connections are not shown between the various components illustrated in FIG. 5, it should be understood that some, none, or all of the components illustrated in FIG. 5 can be configured to interact with one another to carry out various device functions. In some embodiments, the components are arranged so as to communicate via one or more busses (not shown). Thus, it should be understood that FIG. 5 and the following description are intended to provide a general understanding of a suitable environment in which various aspects of embodiments can be implemented, and should not be construed as being limiting in any way.

As illustrated in FIG. 5, the mobile device 500 can include a display 502 for displaying data. According to various embodiments, the display 502 can be configured to display various GUI elements, text, images, video, virtual keypads and/or keyboards, messaging data, notification messages, metadata, Internet content, device status, time, date, calendar data, device preferences, map and location data, combinations thereof, and/or the like. The mobile device 500 also can include a processor 504 and a memory or other data storage device (“memory”) 506. The processor 504 can be configured to process data and/or can execute computer-executable instructions stored in the memory 506. The computer-executable instructions executed by the processor 504 can include, for example, an operating system 508, one or more applications 510, other computer-executable instructions stored in the memory 506, or the like. The applications 510 can include the flood index algorithm module 124, the plotting module 128, the hydrological potential energy module 130, and the reporting module 132. These modules can be combined in a single application. In some embodiments, the applications 510 also can include a UI application (not illustrated in FIG. 5). The memory 506 also can store the flood index algorithm 126, the flood index data 134, the flood index graph 136, the hydrological potential energy data 144, and the report 146.

The UI application can interface with the operating system 508 to facilitate user interaction with functionality and/or data stored at the mobile device 500 and/or stored elsewhere. In some embodiments, the operating system 508 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the MS family of operating systems from APPLE INC., a member of the ANDROID OS family of operating systems from GOOGLE LLC, and/or other operating systems. These operating systems are merely illustrative of some contemplated operating systems that may be used in accordance with various embodiments of the concepts and technologies described herein and therefore should not be construed as being limiting in any way.

The UI application can be executed by the processor 504 to aid a user in entering/deleting data, entering and setting user IDs and passwords for device access, configuring settings, manipulating content and/or settings, multimode interaction, interacting with other applications 510, and otherwise facilitating user interaction with the operating system 508, the applications 510, and/or other types or instances of data 512 that can be stored at the mobile device 500.

The applications 510, the data 512, and/or portions thereof can be stored in the memory 506 and/or in a firmware 514, and can be executed by the processor 504. The firmware 514 also can store code for execution during device power up and power down operations. It can be appreciated that the firmware 514 can be stored in a volatile or non-volatile data storage device including, but not limited to, the memory 506 and/or a portion thereof.

The mobile device 500 also can include an input/output (“I/O”) interface 516. The I/O interface 516 can be configured to support the input/output of data such as location information, presence status information, user IDs, passwords, and application initiation (start-up) requests. In some embodiments, the I/O interface 516 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45) port, an RJ11 port, a proprietary port, combinations thereof, or the like. In some embodiments, the mobile device 500 can be configured to synchronize with another device to transfer content to and/or from the mobile device 500. In some embodiments, the mobile device 500 can be configured to receive updates to one or more of the applications 510 via the I/O interface 516, though this is not necessarily the case. In some embodiments, the I/O interface 516 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 516 may be used for communications between the mobile device 500 and a network device or local device.

The mobile device 500 also can include a communications component 518. The communications component 518 can be configured to interface with the processor 504 to facilitate wired and/or wireless communications with one or more networks, such as the network 120, the Internet, or some combination thereof. In some embodiments, the communications component 518 includes a multimode communications subsystem for facilitating communications via the cellular network and one or more other networks.

The communications component 518, in some embodiments, includes one or more transceivers. The one or more transceivers, if included, can be configured to communicate over the same and/or different wireless technology standards with respect to one another. For example, in some embodiments, one or more of the transceivers of the communications component 518 may be configured to communicate using Global System for Mobile communications (“GSM”), Code-Division Multiple Access (“CDMA”) CDMAONE, CDMA2000, Long-Term Evolution (“LTE”) LTE, and various other 2G, 2.5G, 3G, 4G, 4.5G, 5G, and greater generation technology standards. Moreover, the communications component 518 may facilitate communications over various channel access methods (which may or may not be used by the aforementioned standards) including, but not limited to, Time-Division Multiple Access (“TDMA”), Frequency-Division Multiple Access (“FDMA”), Wideband CDMA (“W-CDMA”), Orthogonal Frequency-Division Multiple Access (“OFDMA”), Space-Division Multiple Access (“SDMA”), and the like.

In addition, the communications component 518 may facilitate data communications using General Packet Radio Service (“GPRS”), Enhanced Data services for Global Evolution (“EDGE”), the High-Speed Packet Access (“HSPA”) protocol family including High-Speed Downlink Packet Access (“HSDPA”), Enhanced Uplink (“EUL”) (also referred to as High-Speed Uplink Packet Access (“HSUPA”), HSPA+, and various other current and future wireless data access standards. In the illustrated embodiment, the communications component 518 can include a first transceiver (“TxRx”) 520A that can operate in a first communications mode (e.g., GSM). The communications component 518 also can include an N^{th} transceiver (“TxRx”) 520N that can operate in a second communications mode relative to the first transceiver 520A (e.g., UMTS). While two transceivers 520A-520N (hereinafter collectively and/or generically referred to as “transceivers 520”) are shown in FIG. 5, it should be appreciated that less than two, two, and/or more than two transceivers 520 can be included in the communications component 518.

The communications component 518 also can include an alternative transceiver (“Alt TxRx”) 522 for supporting other types and/or standards of communications. According to various contemplated embodiments, the alternative transceiver 522 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 518 also can facilitate reception from terrestrial radio networks, digital satellite radio networks, internet-based radio service networks, combinations thereof, and the like. The communications component 518 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 500 also can include one or more sensors 524. The sensors 524 can include temperature sensors, light sensors, air quality sensors, movement sensors, accelerometers, magnetometers, gyroscopes, infrared sensors, orientation sensors, noise sensors, microphones proximity sensors, combinations thereof, and/or the like. Additionally, audio capabilities for the mobile device 500 may be provided by an audio I/O component 526. The audio I/O component 526 of the mobile device 500 can include one or more speakers for the output of audio signals, one or more microphones for the collection and/or input of audio signals, and/or other audio input and/or output devices.

The illustrated mobile device 500 also can include a subscriber identity module (“SIM”) system 528. The SIM system 528 can include a universal SIM (“USIM”), a universal integrated circuit card (“UICC”) and/or other identity devices. The SIM system 528 can include and/or can be connected to or inserted into an interface such as a slot interface 530. In some embodiments, the slot interface 530 can be configured to accept insertion of other identity cards or modules for accessing various types of networks. Additionally, or alternatively, the slot interface 530 can be configured to accept multiple subscriber identity cards. Because other devices and/or modules for identifying users and/or the mobile device 500 are contemplated, it should be understood that these embodiments are illustrative, and should not be construed as being limiting in any way.

The mobile device 500 also can include an image capture and processing system 532 (“image system”). The image system 532 can be configured to capture or otherwise obtain photos, videos, and/or other visual information. As such, the image system 532 can include cameras, lenses, charge-coupled devices (“CCDs”), combinations thereof, or the like. The mobile device 500 may also include a video system 534. The video system 534 can be configured to capture, process, record, modify, and/or store video content. Photos and videos obtained using the image system 532 and the video system 534, respectively, may be added as message content to an MMS message, email message, and sent to another device. The video and/or photo content also can be shared with other devices via various types of data transfers via wired and/or wireless communication devices as described herein.

The mobile device 500 also can include one or more location components 536. The location components 536 can be configured to send and/or receive signals to determine a geographic location of the mobile device 500. According to various embodiments, the location components 536 can send and/or receive signals from global positioning system (“GPS”) devices, assisted-GPS (“A-GPS”) devices, WI-FI/WIMAX and/or cellular network triangulation data, combinations thereof, and the like. The location component 536 also can be configured to communicate with the communications component 518 to retrieve triangulation data for determining a location of the mobile device 500. In some embodiments, the location component 536 can interface with cellular network nodes, telephone lines, satellites, location transmitters and/or beacons, wireless network transmitters and receivers, combinations thereof, and the like. In some embodiments, the location component 536 can include and/or can communicate with one or more of the sensors 524 such as a compass, an accelerometer, and/or a gyroscope to determine the orientation of the mobile device 500. Using the location component 536, the mobile device 500 can generate and/or receive data to identify its geographic location, or to transmit data used by other devices to determine the location of the mobile device 500. The location component 536 may include multiple components for determining the location and/or orientation of the mobile device 500.

The illustrated mobile device 500 also can include a power source 538. The power source 538 can include one or more batteries, power supplies, power cells, and/or other power subsystems including alternating current (“AC”) and/or direct current (“DC”) power devices. The power source 538 also can interface with an external power system or charging equipment via a power I/O component 540. Because the mobile device 500 can include additional and/or alternative components, the above embodiment should be understood as being illustrative of one possible operating environment for various embodiments of the concepts and technologies described herein. The described embodiment of the mobile device 500 is illustrative, and should not be construed as being limiting in any way.

As used herein, communication media includes computer-executable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared, and other wireless media. Combinations of the any of the above should also be included within the scope of computer-readable media.

By way of example, and not limitation, computer storage media may include volatile and non-volatile, removable and non-removable media implemented in any method or technology for storage of information such as computer-executable instructions, data structures, program modules, or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the mobile device 500 or other devices or computers described herein, such as the computer system 400 described above with reference to FIG. 4. In the claims, the phrase “computer storage medium,” “computer-readable storage medium,” and variations thereof does not include waves or signals per se and/or communication media, and therefore should be construed as being directed to “non-transitory” media only.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations may take place in the mobile device 500 in order to store and execute the software components presented herein. It is also contemplated that the mobile device 500 may not include all of the components shown in FIG. 5, may include other components that are not explicitly shown in FIG. 5, or may utilize an architecture completely different than that shown in FIG. 5.

Turning now to FIG. 6, details of the network 120 are illustrated, according to an illustrative embodiment. The network 120 includes a cellular network 602, a packet data network 604, and a circuit switched network 606 (e.g., a public switched telephone network). The cellular network 602 includes various components such as, but not limited to, base transceiver stations (“BTSs”), Node-Bs or e-Node-Bs, base station controllers (“BSCs”), radio network controllers (“RNCs”), mobile switching centers (“MSCs”), mobility management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, and the like. The cellular network 602 also includes radios and nodes for receiving and transmitting voice, data, and combinations thereof to and from radio transceivers, networks, the packet data network 604, and the circuit switched network 606.

A mobile communications device 608, such as, for example, the mobile device 500, a cellular telephone, a user equipment, a mobile terminal, a PDA, a laptop computer, a handheld computer, and combinations thereof, can be operatively connected to the cellular network 602. The mobile communications device 608 can be configured similar to or the same as the mobile device 500 described above with reference to FIG. 5.

The cellular network 602 can be configured as a GSM network and can provide data communications via GPRS and/or EDGE. Additionally, or alternatively, the cellular network 602 can be configured as a 3G Universal Mobile Telecommunications System (“UMTS”) network and can provide data communications via the HSPA protocol family, for example, HSDPA, EUL, and HSPA+. The cellular network 602 also is compatible with mobile communications standards such as LTE, or the like, as well as evolved and future mobile standards.

The packet data network 604 includes various systems, devices, servers, computers, databases, and other devices in communication with one another, as is generally known. The weather data source(s) 112, the weather operations center 122, the predictive hydrological impact diagnostic system 102, and the other device(s) 148 can communicate with each other via the packet data network 604. In some embodiments, the packet data network 604 is or includes one or more WI-FI networks, each of which can include one or more WI-FI access points, routers, switches, and other WI-FI network components. The packet data network 604 devices are accessible via one or more network links. The servers often store various files that are provided to a requesting device such as, for example, a computer, a terminal, a smartphone, or the like. Typically, the requesting device includes software for executing a web page in a format readable by the browser or other software. Other files and/or data may be accessible via “links” in the retrieved files, as is generally known. In some embodiments, the packet data network 604 includes or is in communication with the Internet. The circuit switched network 606 includes various hardware and software for providing circuit switched communications. The circuit switched network 606 may include, or may be, what is often referred to as a plain old telephone system (“POTS”). The functionality of a circuit switched network 606 or other circuit-switched network are generally known and will not be described herein in detail.

The illustrated cellular network 602 is shown in communication with the packet data network 604 and a circuit switched network 606, though it should be appreciated that this is not necessarily the case. One or more Internet-capable systems/devices 610 such as the predictive hydrological impact diagnostic system 102, the weather data source(s) 112, the other device(s) 148, a laptop, a portable device, or another suitable device, can communicate with one or more cellular networks 602, and devices connected thereto, through the packet data network 604. It also should be appreciated that the Internet-capable device 610 can communicate with the packet data network 604 through the circuit switched network 606, the cellular network 602, and/or via other networks (not illustrated).

As illustrated, a communications device 612, for example, a telephone, facsimile machine, modem, computer, or the like, can be in communication with the circuit switched network 606, and therethrough to the packet data network 604 and/or the cellular network 602. It should be appreciated that the communications device 612 can be an Internet-capable device, and can be substantially similar to the Internet-capable device 610.

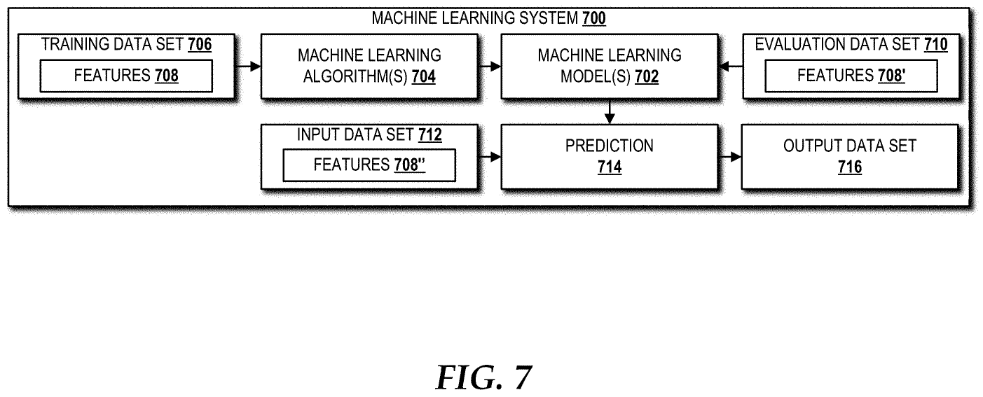

Turning now to FIG. 7, a machine learning system 700 capable of implementing aspects of the embodiments disclosed herein will be described. In some embodiments, aspects of the predictive hydrological impact diagnostic system 102 can be improved via machine learning. Accordingly, the predictive hydrological impact diagnostic system 102 can include the machine learning system 700 or can be in communication with the machine learning system 700.

The illustrated machine learning system 700 includes one or more machine learning models 702. The machine learning models 702 can include, unsupervised, supervised, and/or semi-supervised learning models. The machine learning model(s) 702 can be created by the machine learning system 700 based upon one or more machine learning algorithms 704. The machine learning algorithm(s) 704 can be any existing, well-known algorithm, any proprietary algorithms, or any future machine learning algorithm. Some example machine learning algorithms 704 include, but are not limited to, neural networks, gradient descent, linear regression, logistic regression, linear discriminant analysis, classification tree, regression tree, Naive Bayes, K-nearest neighbor, learning vector quantization, support vector machines, any of the algorithms described herein, and the like. Classification and regression algorithms might find particular applicability to the concepts and technologies disclosed herein. Those skilled in the art will appreciate the applicability of various machine learning algorithms 704 based upon the problem(s) to be solved by machine learning via the machine learning system 700.

The machine learning system 700 can control the creation of the machine learning models 702 via one or more training parameters. In some embodiments, the training parameters are selected modelers at the direction of an enterprise, for example. Alternatively, in some embodiments, the training parameters are automatically selected based upon data provided in one or more training data sets 706. The training parameters can include, for example, a learning rate, a model size, a number of training passes, data shuffling, regularization, and/or other training parameters known to those skilled in the art.

The learning rate is a training parameter defined by a constant value. The learning rate affects the speed at which the machine learning algorithm 704 converges to the optimal weights. The machine learning algorithm 704 can update the weights for every data example included in the training data set 706. The size of an update is controlled by the learning rate. A learning rate that is too high might prevent the machine learning algorithm 704 from converging to the optimal weights. A learning rate that is too low might result in the machine learning algorithm 704 requiring multiple training passes to converge to the optimal weights.

The model size is regulated by the number of input features (“features”) 708 in the training data set 706. A greater the number of features 708 yields a greater number of possible patterns that can be determined from the training data set 706. The model size should be selected to balance the resources (e.g., compute, memory, storage, etc.) needed for training and the predictive power of the resultant machine learning model 702.

The number of training passes indicates the number of training passes that the machine learning algorithm 704 makes over the training data set 706 during the training process. The number of training passes can be adjusted based, for example, on the size of the training data set 706, with larger training data sets being exposed to fewer training passes in consideration of time and/or resource utilization. The effectiveness of the resultant machine learning model 702 can be increased by multiple training passes.

Data shuffling is a training parameter designed to prevent the machine learning algorithm 704 from reaching false optimal weights due to the order in which data contained in the training data set 706 is processed. For example, data provided in rows and columns might be analyzed first row, second row, third row, etc., and thus an optimal weight might be obtained well before a full range of data has been considered. By data shuffling, the data contained in the training data set 706 can be analyzed more thoroughly and mitigate bias in the resultant machine learning model 702.

Regularization is a training parameter that helps to prevent the machine learning model 702 from memorizing training data from the training data set 706. In other words, the machine learning model 702 fits the training data set 706, but the predictive performance of the machine learning model 702 is not acceptable. Regularization helps the machine learning system 700 avoid this overfitting/memorization problem by adjusting extreme weight values of the features 708. For example, a feature that has a small weight value relative to the weight values of the other features in the training data set 706 can be adjusted to zero.

The machine learning system 700 can determine model accuracy after training by using one or more evaluation data sets 710 containing the same features 708′ as the features 708 in the training data set 706. This also prevents the machine learning model 702 from simply memorizing the data contained in the training data set 706. The number of evaluation passes made by the machine learning system 700 can be regulated by a target model accuracy that, when reached, ends the evaluation process and the machine learning model 702 is considered ready for deployment.

After deployment, the machine learning model 702 can perform a prediction operation (“prediction”) 714 with an input data set 712 having the same features 708″ as the features 708 in the training data set 706 and the features 708′ of the evaluation data set 710. The results of the prediction 714 are included in an output data set 716 consisting of predicted data. The machine learning model 702 can perform other operations, such as regression, classification, and others. As such, the example illustrated in FIG. 7 should not be construed as being limiting in any way.

Turning now to FIG. 8, a block diagram illustrating an example virtualized cloud architecture 800 and components thereof will be described, according to an exemplary embodiment. In some embodiments, the virtualized cloud architecture 800 can be utilized to implement, at least in part, the predictive hydrological impact diagnostic system 102, the weather data source(s) 112, the other device(s) 148, and/or the network(s) 120 or a portion thereof. The virtualized cloud architecture 800 is a shared infrastructure that can support multiple services and network applications. The illustrated virtualized cloud architecture 800 includes a hardware resource layer 802, a control layer 804, a virtual resource layer 806, and an application layer 808 that work together to perform operations as will be described in detail herein.

The hardware resource layer 802 provides hardware resources, which, in the illustrated embodiment, include one or more compute resources 810, one or more memory resources 812, and one or more other resources 814. The compute resource(s) 810 can include one or more hardware components that perform computations to process data, and/or to execute computer-executable instructions of one or more application programs, operating systems, and/or other software. The compute resources 810 can include one or more central processing units (“CPUs”) configured with one or more processing cores. The compute resources 810 can include one or more graphics processing unit (“GPU”) configured to accelerate operations performed by one or more CPUs, and/or to perform computations to process data, and/or to execute computer-executable instructions of one or more application programs, operating systems, and/or other software that may or may not include instructions particular to graphics computations. In some embodiments, the compute resources 810 can include one or more discrete GPUs. In some other embodiments, the compute resources 810 can include CPU and GPU components that are configured in accordance with a co-processing CPU/GPU computing model, wherein the sequential part of an application executes on the CPU and the computationally-intensive part is accelerated by the GPU. The compute resources 810 can include one or more system-on-chip (“SoC”) components along with one or more other components, including, for example, one or more of the memory resources 812, and/or one or more of the other resources 814. In some embodiments, the compute resources 810 can be or can include one or more SNAPDRAGON SoCs, available from QUALCOMM; one or more TEGRA SoCs, available from NVIDIA; one or more HUMMINGBIRD SoCs, available from SAMSUNG; one or more Open Multimedia Application Platform (“OMAP”) SoCs, available from TEXAS INSTRUMENTS; one or more customized versions of any of the above SoCs; and/or one or more proprietary SoCs. The compute resources 810 can be or can include one or more hardware components architected in accordance with an advanced reduced instruction set computing (“RISC”) machine (“ARM”) architecture, available for license from ARM HOLDINGS. Alternatively, the compute resources 810 can be or can include one or more hardware components architected in accordance with an x86 architecture, such an architecture available from INTEL CORPORATION of Mountain View, Calif., and others. Those skilled in the art will appreciate the implementation of the compute resources 810 can utilize various computation architectures, and as such, the compute resources 810 should not be construed as being limited to any particular computation architecture or combination of computation architectures, including those explicitly disclosed herein.

The memory resource(s) 812 can include one or more hardware components that perform storage operations, including temporary or permanent storage operations. In some embodiments, the memory resource(s) 812 include volatile and/or non-volatile memory implemented in any method or technology for storage of information such as computer-readable instructions, data structures, program modules, or other data disclosed herein. For example, the memory resource(s) 812 can contain the flood index algorithm module 124, the plotting module 128, the hydrological potential energy module 130, and the reporting module 132. The memory resource(s) 812 also can store the flood index algorithm 126, the flood index data 134, the flood index graph 136, the hydrological potential energy data 144, and the report 146. Computer storage media includes, but is not limited to, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store data and which can be accessed by the compute resources 810.

The other resource(s) 814 can include any other hardware resources that can be utilized by the compute resources(s) 810 and/or the memory resource(s) 812 to perform operations described herein. The other resource(s) 814 can include one or more input and/or output processors (e.g., network interface controller or wireless radio), one or more modems, one or more codec chipset, one or more pipeline processors, one or more fast Fourier transform (“FFT”) processors, one or more digital signal processors (“DSPs”), one or more speech synthesizers, and/or the like.

The hardware resources operating within the hardware resource layer 802 can be virtualized by one or more virtual machine monitors (“VMMs”) 816A-816N (also known as “hypervisors”; hereinafter “VMA/Is 816”) operating within the control layer 804 to manage one or more virtual resources that reside in the virtual resource layer 806. The VMMs 816 can be or can include software, firmware, and/or hardware that alone or in combination with other software, firmware, and/or hardware, manages one or more virtual resources operating within the virtual resource layer 806.

The virtual resources operating within the virtual resource layer 806 can include abstractions of at least a portion of the compute resources 810, the memory resources 812, the other resources 814, or any combination thereof. These abstractions are referred to herein as virtual machines (“VMs”). In the illustrated embodiment, the virtual resource layer 806 includes VMs 818A-818N (hereinafter “VMs 818”). Each of the VMs 818 can execute one or more applications 820A-820N in the application layer 808.

Based on the foregoing, it should be appreciated that aspects of predictive hydrological impact diagnostic system have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A method comprising:
obtaining, by a system comprising a processor, weather data associated with an area, wherein the weather data comprises an interval rainfall forecast and a total accumulated rainfall forecast for the area;
executing, by the system, a flood index algorithm using the interval rainfall forecast and the total accumulated rainfall forecast;
in response to executing the flood index algorithm, obtaining, by the system, an output of the flood index algorithm, wherein the output comprises a flood index data for the area;
plotting, by the system, the flood index data on a graph to show a forecasted rainfall intensity over a time;
determining, by the system, a threshold value; and
determining, by the system, a hydrological potential energy data for the area, wherein the hydrological potential energy data is representative of a cumulative area of the graph that is above the threshold value.

2. The method of claim 1, wherein executing, by the system, the flood index algorithm further comprises executing the flood index algorithm further using a time interval constant, a heavy rain threshold parameter, and a total rainfall threshold parameter.

3. The method of claim 2, wherein the flood index algorithm defines the flood index data as being equal to
$$( \frac{( X * Y )}{Z} ) * ( \frac{T}{U} )$$
wherein:
X is representative of a current 15-minute time interval of the interval rainfall forecast;
T is representative of the total accumulated rainfall forecast up to and including the current 15-minute time interval;
the time interval constant is 4, which is representative of a number of 15 minute time intervals in one hour;
the heavy rain constant is 0.31, which is representative of a number of inches of rain per hour that is considered to be heavy; and
the total rainfall threshold parameter is 2.1, which is representative a total number of inches of rain that is considered to be heavy when compared to a resident soil moisture.

4. The method of claim 3, wherein the threshold value is 6.09.

5. The method of claim 4, wherein the area comprises a building.

6. The method of claim 5, further comprising storing, by the system, the flood index data and the hydrological potential energy data in association with the area.

7. The method of claim 6, further comprising determining, by the system, based upon the flood index data and the hydrological potential energy data that the building is at risk of a flood event.

8. The method of claim 7, further comprising outputting, by the system, a report identifying that the building is at risk of the flood event.

9. A system comprising:
a processor; and
a memory comprising instructions that, when executed by the processor, cause the processor to perform operations comprising
obtaining weather data associated with an area, wherein the weather data comprises an interval rainfall forecast and a total accumulated rainfall forecast for the area,
executing a flood index algorithm using the interval rainfall forecast and the total accumulated rainfall forecast,
in response to executing the flood index algorithm, obtaining an output of the flood index algorithm, wherein the output comprises a flood index data for the area,
plotting the flood index data on a graph to show a forecasted rainfall intensity over a time,
determining a threshold value, and
determining a hydrological potential energy data for the area, wherein the hydrological potential energy data is representative of a cumulative area of the graph that is above the threshold value.

10. The system of claim 9, wherein executing the flood index algorithm further comprises executing the flood index algorithm further using a time interval constant, a heavy rain constant, and a total rainfall threshold constant.

11. The system of claim 10, wherein the flood index algorithm defines the flood index data as being equal to
$$( \frac{( X * Y )}{Z} ) * ( \frac{T}{U} )$$
wherein:
X is representative of a current 15-minute time interval of the interval rainfall forecast;
T is representative of the total accumulated rainfall forecast up to and including the current 15-minute time interval;
the time interval constant is 4, which is representative of a number of 15 minute time intervals in one hour;
the heavy rain threshold parameter is 0.31, which is representative of a number of inches of rain per hour that is considered to be heavy; and
the total rainfall threshold parameter is 2.1, which is representative of a total number of inches of rain that is considered to be heavy when compared to a resident soil moisture.

12. The system of claim 11, wherein the threshold value is 6.09.

13. The system of claim 12, wherein the area comprises a building.

14. The system of claim 13, wherein the operations further comprise storing the flood index data and the hydrological potential energy data in association with the area.

15. The system of claim 14, wherein the operations further comprise determining, by the system, based upon the flood index data and the hydrological potential energy data that the building is at risk of a flood event.

16. The system of claim 15, wherein the operations further comprise outputting a report identifying that the building is at risk of the flood event.

17. A computer-readable storage medium comprising computer-executable instructions that, when executed by a processor, cause the processor to perform operations comprising:
obtaining weather data associated with an area, wherein the weather data comprises an interval rainfall forecast and a total accumulated rainfall forecast for the area;
executing a flood index algorithm using the interval rainfall forecast and the total accumulated rainfall forecast;
in response to executing the flood index algorithm, obtaining an output of the flood index algorithm, wherein the output comprises a flood index data for the area;
plotting the flood index data on a graph to show a forecasted rainfall intensity over a time;
determining a threshold value; and
determining a hydrological potential energy data for the area, wherein the hydrological potential energy data is representative of a cumulative area of the graph that is above the threshold value.

18. The computer-readable storage medium of claim 17, wherein executing the flood index algorithm further comprises executing the flood index algorithm further using a time interval constant, a heavy rain threshold parameter, and a total rainfall threshold parameter.

19. The computer-readable storage medium of claim 18, wherein the flood index algorithm defines the flood index data as being equal to
$$( \frac{( X * Y )}{Z} ) * ( \frac{T}{U} )$$
wherein:
X is representative of a current 15-minute time interval of the interval rainfall forecast;
T is representative of the total accumulated rainfall forecast up to and including the current 15-minute time interval;
the time interval constant is 4, which is representative of a number of 15 minute time intervals in one hour;
the heavy rain threshold parameter is 0.31, which is representative of a number of inches of rain per hour that is considered to be heavy; and
the total rainfall threshold parameter is 2.1, which is representative of a total number of inches of rain that is considered to be heavy when compared to a resident soil moisture.

20. The computer-readable storage medium of claim 19, wherein the threshold value is 6.09.
